(19) United States
(12) Patent Application Publication
(10) Pub. No.: US 2006/0019071 A1
(43) Pub. Date: Jan. 26, 2006

(54) Label and method of producing the same

(76) Inventor: Shoichi Akita, Osaka-shi (JP)

Correspondence Address: THE WEBB LAW FIRM, P.C., 700 KOPPERS BUILDING, 436 SEVENTH AVENUE, PITTSBURGH, PA, 15219, US

(21) Appl. No.: 10/533,220

(22) PCT Filed: Oct. 29, 2003
(86) PCT No.: PCT/JP03/13828

§ 371 Date: Apr. 28, 2005

(30) Foreign Application Priority Data
Oct. 30, 2002 (JP) 2002-315564

(51) Int. Cl. B32B 3/12

(52) U.S. Cl. 428/158

(57) ABSTRACT

Disclosed are a label and a method of manufacturing labels that are capable of preventing the hand from being heated when the label is used for such as a hot drink, while making a bottle body with the label applied thereto hard to slip off from the hand when the bottle body is picked up, as well as providing a design having a perspective and three dimensional effect. A label of the present invention is made of foam sheet having a foam layer, in which an outer side of the label has linear depressions formed by pressing the foam sheet so as to have partially thinned portions and hence provide an uneven surface portion.

### FIELD OF THE INVENTION

This invention relates to a label adapted to be attached a body of a glass bottle, a metal can or a synthetic resin container and a method of manufacturing labels.

### BACKGROUND OF THE INVENTION

Conventionally, there exists a label made of foam sheet such as foamed polystyrene. It is known that such a label can be used as a label adapted to be attached to such as a glass bottle, a metal can or a plastic container so as to provide them with heat insulating capacity and cushioning capacity. The label of this type has an outer side on which a trade name, a pattern or other designs are printed to have a printed layer. The surface of the printed layer is frequently coated with varnish (overcoat) having excellent slipping and heat-resisting characteristics for protection of the printed layer such as design, prevention of blocking with a printed surface of a different container, as well as for bringing a container conveyor into a good condition or prevention of blocking-up of the conveyor.

A thus produced design only by printing has a flattened appearance and is hard to have a perspective effect. When attempt is made to provide a three-dimensional design with a perspective effect by printing, it is necessary to form protrusions and recesses by varying the amount of ink laid down. This causes increase in the amount of ink, necessarily makes ink hard to be dried and hence lowers the productivity, as well as requires a specially designed printing machine. In a case where protrusions and recesses are formed with ink, the height or depth of the protrusions and recesses is also limited. Furthermore, in a case where a foam sheet is coated thereon with varnish as described above, this varnish can protect a printed layer or prevent blocking between labels; however is extremely slippy. Because f this, when a container body with hot drink filled therein is held by the hand through a label, care must be made not to drop the container body due to extremely slippy surface of the label. Specifically, for a cylindrical metal can, special care must be made since it has a constant diameter along its lengthwise direction.

The present invention has been conceived in consideration of the above problems. It is an object of the present invention to provide a label that is capable of preventing the hand of a person who holds a container body from being heated when used for such as a hot drink, while making a bottle body with the label applied thereto hard to slip off from the hand when the bottle body has been picked up, as well as providing a method of manufacturing such a label.

### SUMMARY OF THE INVENTION

According to the present invention, a label and a method of manufacturing the same were conceived in order to achieve the above objects. A label for being attached to a main part of the body of a container is characterized in that the label is made of foam sheet having a foam layer, in which an outer side of the label has linear depressions formed by pressing the foam sheet so as to have partially thinned portions and hence provide an uneven surface portion.

With the label having the foam layer, even when a drink filled in the body of the container is heated, heat of the drink is hard to be transferred to the hand because of the heat insulating capacity of the label attached to the body of the container. In addition, when the body of the container is picked up through the label by the hand, it is hard to slip and hence hard to drop from the hand thanks to the uneven surface portion of the outer side of the label, which also creates a decorative effect.

A heat sensitive adhesive layer is preferably formed on the inner side of the label. The heat sensitive adhesive layer formed on the inner side facilitates the label to be attached to the body of the container and securely prevents the label from being displaced after the attachment because the label is bonded to the body of the container. In addition, the adhesive, which is of a heat sensitive type, can easily and instantly make the label to be attached to the body of the container by activating the heat sensitive adhesive by the application of heat.

When the heat sensitive adhesive layer is provided entirely on the inner side of the label, it has an advantage of easily producing a bonding strength with the body of the container; on the other hand, where the heat sensitive adhesive layer is provided only along the opposite edges of the label, the amount of the adhesive can be reduced. Where the heat sensitive adhesive layer is provided only along the opposite edges, it is possible to employ an arrangement where the label is formed into a cylindrical shape with its opposite edges overlapped to each other and then fitted around the container, as well as the arrangement where the opposite edges of the label are respectively bonded the body of the container via the heat sensitive adhesive layer. Whether the heat sensitive adhesive layer is entirely provided on the inner side of the label or provided only along the opposite edges, it is possible to have one end of the label bonded to the body of the container, then place the label around the body of the container and then have another end of the label overlapped to the one end of the label and bonded thereto.

The foam layer is preferably made of foamed polystyrene resin and the linear depressions each having a width of 0.5-3.0 mm. The foamed polystyrene resin has stiffness and therefore causes less deformation around each linear depression. In addition, such a narrow width, namely 0.5-3.0 mm width of each depression, makes it less likely to have the thinner portions of the linear depressions of the foam sheet touched by the hand when the body of the container is held by that hand. As a result, the heat insulating capacity is unlikely to be reduced.

The characteristics of the label manufacturing method lies in that it comprises pressing an outer side of a label made of foam sheet having a foam layer with a resin plate having linear protrusions, thereby producing an embossed portion made up of linear depressions on the outer side of the label.

Since the label has the outer side pressed with the resin plate having the linear protrusions, it is unlikely to cause scratches or cracks on the outer side of the label and therefore unlikely to damage a printed portion of the label.

In that case, it is preferable to provide an embossed portion on the outer side of the label made of foam sheet having the foam layer, while providing an adhesive layer on an inner side of the label. Since the embossed portion is provided on the foam sheet with the adhesive layer formed thereon, it is not necessary to form an adhesive layer in a separate step after providing the embossed portion, thus facilitating formation of the adhesive layer thereon.

A method of manufacturing labels of the present invention is also characterized in that it comprises pressing an outer side of each label made of foam sheet having a foam layer and a heat sensitive adhesive layer on an inner side of the label with a pressing plate having linear protrusions, while applying no heat to the pressing plate, thereby producing an embossed portion made of linear depressions on the outer side of the label.

Since no heat is applied to the pressing plate, there is less possibility to activate heat sensitive adhesive, which acts as adhesive for bonding of the label. Thus, it is easy to manufacture labels having heat sensitive adhesive. Labels each having heat sensitive adhesive can be easily and instantly attached to the body of a container by heating the label in a manufacturing line where containers are filled with contents such as drink.

According to the present invention, there is also provided a label for being attached to a main part of the body of a container, which is characterized in that the label is made of foam sheet having a foam layer, in which an outer side of the label has linear protrusions that are formed by pressing the foam sheet in the thickness direction thereof so as to provide an uneven surface portion.

With the above label, which also has the foam layer, when a drink filled in the body of the container is heated with the label attached to the body of the container, heat of the drink is hard to be transferred to the hand for its heat insulating capacity in the same manner as above. In addition, when the body of the container is picked up by the hand through the label, it is hard to slip and hence hard to drop from the hand thanks to the uneven surface portion of the outer side of the label. The uneven surface portion also creates a decorative effect.

A method of manufacturing labels is characterized in that it comprises pressing an inner side of a label made of foam sheet having a foam layer with a pressing plate having linear protrusions, thereby producing an embossed portion made up of linear protrusions on an outer side of the label.

According to the above label manufacturing method, since the label has the inner side pressed with the pressing plate having the linear protrusions, it is possible to create a decorative effect on the outer side of the label by the protrusions, as well as preventing slippage and improving heat insulating capacity.

### BRIEF DESCRIPTION OF THE DRAWINGS

FIG. 1 is a front view illustrating one embodiment of the present invention.

FIG. 2 is a cross sectional view illustrating the structure of a label of the one embodiment.

FIGS. 3(a)-3(c) are respectively front views of labels.

FIG. 4 is a front view illustrating an essential portion of the label.

FIG. 5(a) is a cross sectional view taken along a line P-P in FIG. 1, as viewed in a direction of arrows, and FIG. 5(b) is a cross sectional view of an essential portion illustrating an overlapped state of the label.

FIG. 6 is a schematic view illustrating a manufacturing process of a lengthwise label.

FIG. 7 is an enlarged view of an essential portion of the manufacturing process.

### DETAILED DESCRIPTION OF THE PREFERRED EMBODIMENTS

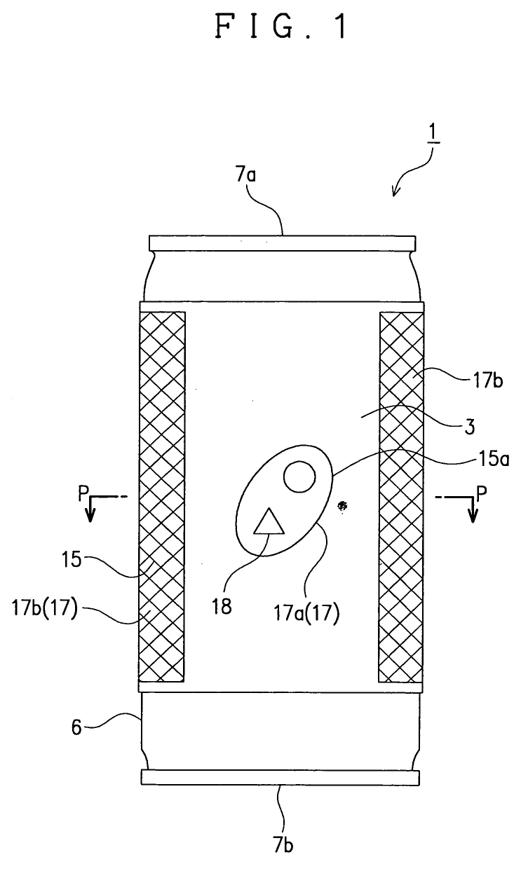

An embodiment of a label of the present invention will be described with reference to the drawings attached. FIG. 1 illustrates a metal can as a container. The metal can is made up of a body (a can body) 1 to be filled with a hot drink and a label 3 attached to a main part 6 of the can body 1.

The can body 1 includes a top lid 7a and a bottom 7b of a bottom lid respectively closing upper and lower openings of the main part 6, in which the top lid 7a and the bottom 7b are secured to the upper and lower ends of the main part 7 such as by fastening them with threaded portions. The main part 6 is so sized as to be held by the hand, and for example has a diameter of 40 mm-100 mm. The can body 1 is formed by using a metal thin plate having a thickness of 0.1 mm-0.4 mm such as an aluminium alloy plate or surface-treated steel plate for plate working.

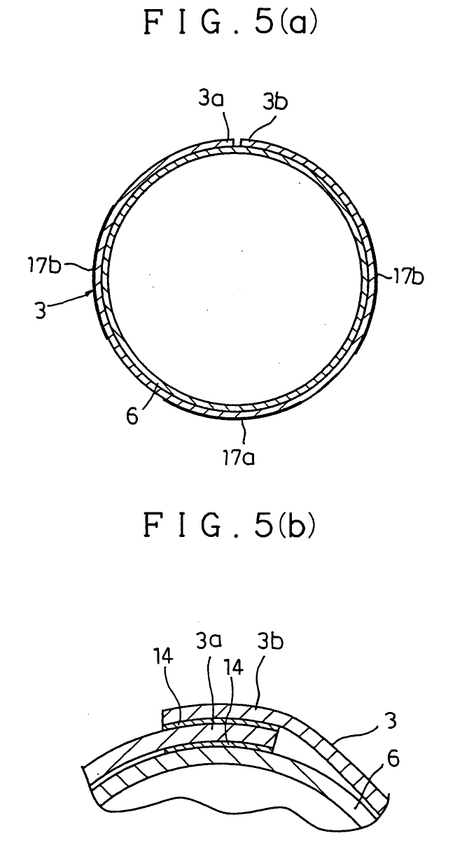

The label 3 is placed around substantially the entire circumference of the main part 6 of the can body 1, as illustrated in FIG. 5(a). In addition to the arrangement where the label 3 has opposite edges 3a, 3b located close to each other, the opposite edges 3a, 3b may be overlapped to each other, as illustrated in FIG. 5(b).

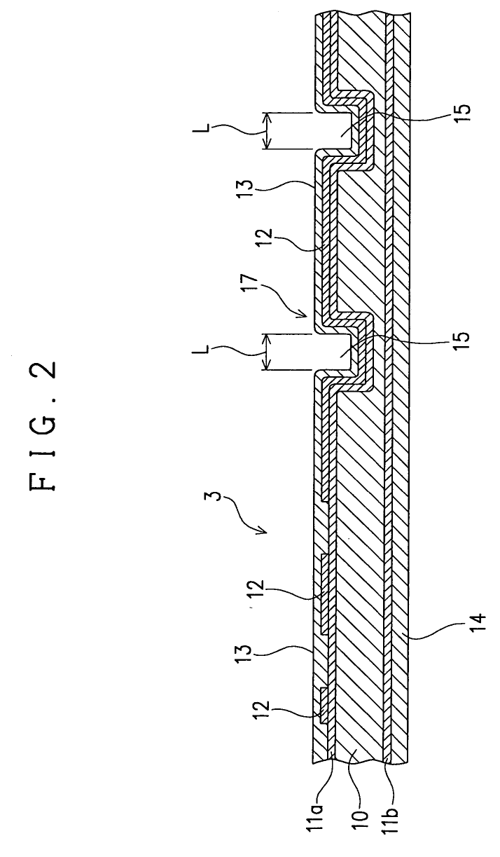

A description will be made for an example of the structure of the label 3 with reference to FIG. 2. The label 3 is made of synthetic resin foam sheet that has a foam layer 10, which provides an excellent heat insulation to a content. Specifically, the label 3 is made up of the foam layer 10 as a label substrate, and non-foam layers 11a, 11b laminated on the front and rear sides (outer and inner sides) of the foam layer 10. The outer non-foam layer 11a is subjected to front printing to have print 12, and an overcoat layer 13 coated on the entire surface of the non-foam layer 11a and the print 12. The entire surface of the rear side of the inwardly located non-foam layer 11b is coated with an adhesive layer (a heat sensitive adhesive layer) 14 made of heat sensitive adhesive such as hot melt or delayed tack that contains as a main component ethylene-vinyl acetate copolymer, ethylene acrylic acid copolymer, ethylene acrylic ester resin or the like by melt extrusion coating, hot melt coating, gravure coating, roll coating or the like process.

In addition to the arrangement with the adhesive layer 14 entirely formed on the inner side of the label 3, the adhesive layer 14 may be formed only along the opposite edges 3a, 3b of the label.3. In FIG. 5(b), the adhesive layer is formed only along the opposite edges 3a, 3b of the label 3, in which the adhesive layer 14 of the first edge 3a allows the label 3 to be bonded to the can body 1 therethrough, while the adhesive layer 14 of the second edge 3b allows the opposite edges 3a, 3b to be bonded together. In this respect, it is to be noted that even where the opposite edges 3a, 3b are overlapped to each other as illustrated in FIG. 5(b), the adhesive layer 14 can be formed on the entire surface of the inner side of the label 3.

As the heat sensitive adhesive, those having such adhesive force as not to be weakened at a temperature between 60° C. and 65° C. (or having such adhesive force as not to be easily peeled away) are used. It is also possible to use acrylic or rubber adhesive for the adhesive layer 14.

The foam layer 10 is made of foamed polystyrene resin having an expansion ratio of 2 to 10 times and preferably 3 to 7 times, and a thickness of 120 μm to 400 μm. As the foamed polystyrene resin, general purpose resin can be used. In addition, a resin that contains as a main component copolymer obtained by copolymerization of polystyrene with butadiene, acrylonitrile, mathacrylic acid, acrylic acid, acrylic acid ester or the like, has a different resin or additive blended therein, and contains 60% by weight or more (preferably 80% by weight or more) of styrene is preferably used. These are expanded by various foaming agents.

The non-foam layers 11a, 11b are provided for the purpose of protecting the inwardly located foam layer 10 against scratches and for the reason that printing thereon is better than printing directly on the foam layer 10. The non-foam layers 11a, 11b each have a thickness of 3-20 μm. The non-foam layers 11a, 11b are made of polystyrene resin. Specifically, they are made of solely polystyrene, styrene butadiene copolymer or styrene acrylic copolymer, or a mixture thereof, and preferably those formed by blending polyethylene or ethylene-vinyl acetate copolymer therein and contains 60% by weight or more of styrene. The non-foam layers 11a, 11b are formed along with the foam layer 10 by co-extrusion.

The non-foam layers may be made of polyethylene or polypropylene resin. Alternatively, a non-foam layer may be formed on either side, or no non-foam layer may be formed on both sides.

The structure as shown in the label 3 is disclosed such as in Japanese Examined Patent Application Publication No. Hei-7-64005 (U.S. Pat. No. 5,082,608) and Japanese Unexamined Patent Application Publication No. Sho-59-71850 (U.S. Pat. No. 4,069,934).

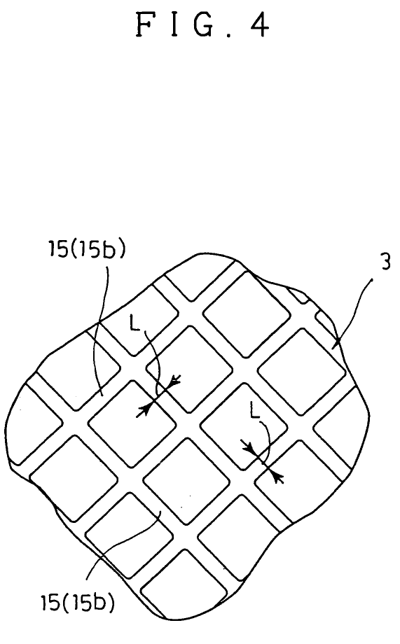

The outer side of the label 3 is embossed. Specifically, linear depressions 15 are formed thereon, as illustrated in FIGS. 2 and 4. The linear depressions 15 each preferably have a width L of 0.5 mm-3.0 mm and more preferably 0.5 mm-2.0 mm. The reason for setting the width L to these ranges is to make the hand hard to touch thinner portions caused by the depressions where a heat insulating effect is lowered. Setting the width of the linear depressions to these ranges makes the depressions easy to be formed and easy to create a decorative effect. The depth of the depressions is for example about 30 μm-50 μm. That is, the thickness of the linear depressions of the label 3 is thinner than that of the residual portion of the label 3. In addition to the linear protrusions 15, planar depressions 15a may be formed on the outer side of the label.

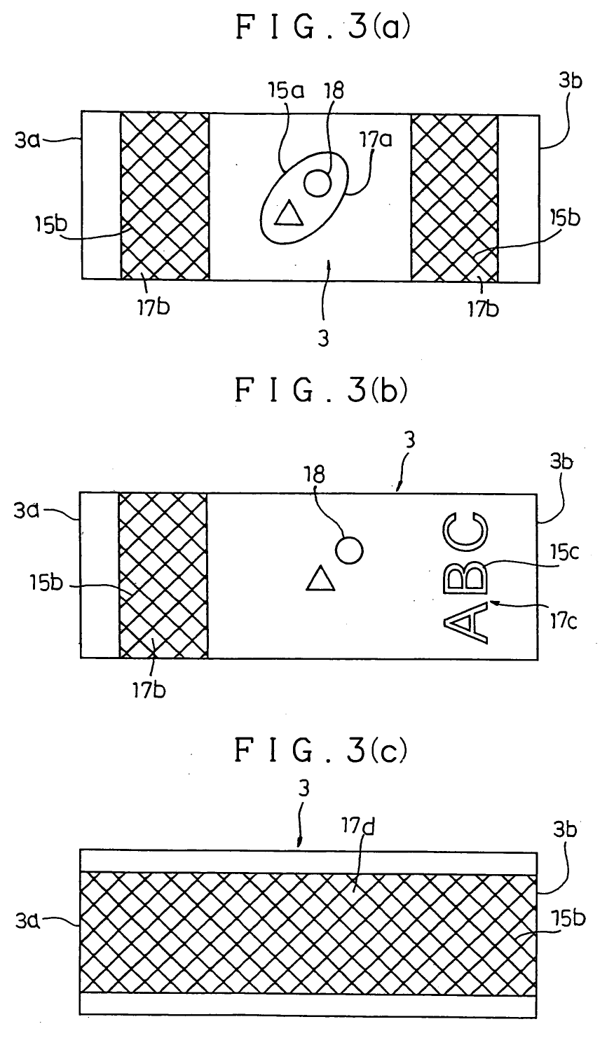

An embossed portion 17 having the linear depressions 15 may be formed in a given portion. For example, as illustrated in FIGS. 1 and 3(a), it is possible to provide an embossed portion 17a arranged around a display area 18 such as a graphic with the curving (circular) linear depressions 15a formed along the edge of the display area 18, or an embossed portion 17b having linear depressions 15b arranged in lattice pattern. The embossed portion 17b having the linear depressions 15b arranged in lattice pattern is formed on each side of the label 3, while the embossed portion 17a around the display area 18 with the linear depressions 15a along the edge of the display area is formed in the center portion of the label 3. The embossed portions 17b formed on the opposite sides of the label 3 is so arranged as to provide a gripping area along a diametrical direction of the main part 6 of the can body 1 when the label 3 is attached to the main part 6.

As illustrated in FIG. 3(b), instead of forming the embossed portions 17a, 17c around the centrally located graphic or display area 18, they may be formed only in portions close to the both ends of the label 3. The embossed portion 17c may be made up of linear depressions 15c along the edge of each character. As illustrated in FIG. 3(c), an embossed portion 17d may be formed along the entire length of the label 3 in the lengthwise direction of the label 3 (a feeding direction of the label).

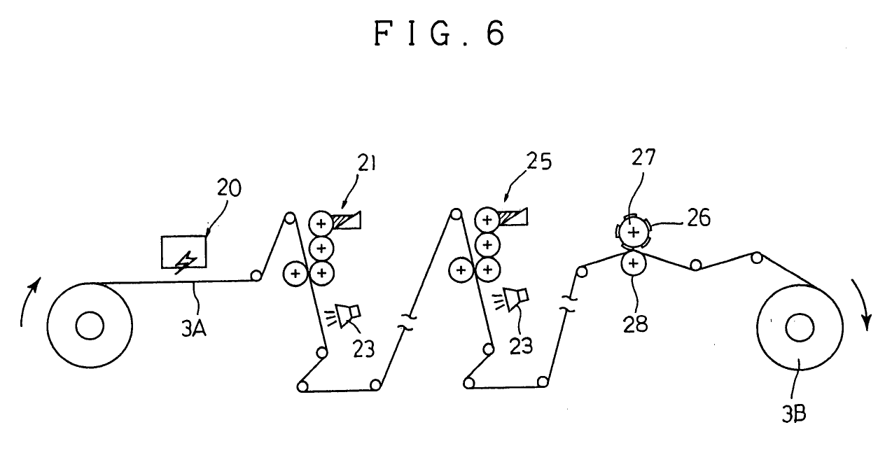

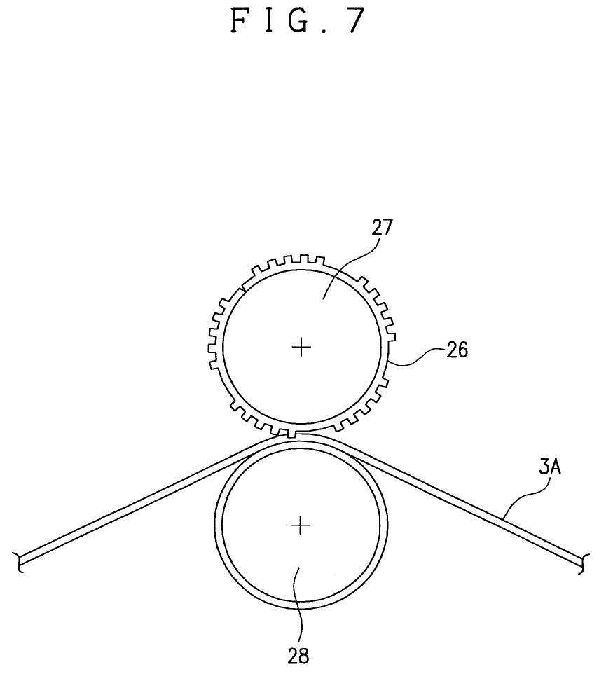

Now, the description will be made for a manufacturing method of the label 3 with reference to FIGS. 6 and 7.

First, a lengthwise material sheet (a sheet with the foam layer 10, the non-foam layers 11a, 11b formed on the front and rear sides of the foam layer 10, and the adhesive layer (heat sensitive adhesive layer) 14 coated on the non-foam layer 11b) 3A is fed so as to have a surface (an outer side) thereof subjected to corona discharge treatment by a corona discharge treatment device 20, while activating the surface of the material sheet 3A as moving the same. Thus, the surface treatment of the material sheet 3A is made so as to be able to increase affinity to ink.

Then, in a printing step, the outer side of the material sheet 3A is subjected to printing by an offset printing press, a flexographic press, a relief rotary press or other conventional printing machine 21 with UV curing ink or the like. It is preferable to use UV curing ink having excellent heat resistance as printing ink for use so as not to be damaged by heat that activates the heat sensitive adhesive layer 14. Plural printing machines 21 are arranged respectively for given colors. In a UV curing step subsequent to the printing step, the printing layer is exposed to UV radiation by a UV lamp 23 for UV curing. As UV curing ink (UV ink), known UV ink can be used. For example, it can be cited ink blended with oligomer such as epoxy acrylate, urethane acrylate or polyester acrylate, and polyester monomer or other monomer containing UV polymerization initiator or coloring agent such as pigment, dispersing agent or additive agent. As typical examples of the UV curing ink, it can be cited “161”, “STP”, “171” and “VECTA” of T&K TOKA COMPANY, “UVACE” of KUBOI-INK CO., LTD., “CP-UV” of MATSUI CHEMICAL CO., LTD and the like.

Furthermore, in an overcoating step, the surface of the ink layer is coated with varnish by a varnish printing machine 25 and then subjected to NV curing treatment. Varnish as used herein may be “UVOP VARNISH SERIES” of T&K TOKA COMPANY, “UVACEOP VARNISH” OF KUBOI-INK CO., LTD or the like. The printing ink and the varnish used herein may be of electron curing type, in place of NV curing type.

Then, in an embossing step, the material sheet 3A, which has been subjected to the printing and subsequent treatments, is fed between an embossing cylinder 27 that has a metal roll, on which a resin plate 26 as a pressing plate with linear depressions having predetermined shape formed thereon is provided, and a receiving cylinder 28, and embossed on given portions of the sheet 3A according to the respective labels 3. The resin plate 26 is made of rigid synthetic resin and made up of such as a base layer of plastic sheet or the like and a rigid photosensitive resin layer (acrylic resin, methacrylic resin or the like). The synthetic resin (the photosensitive resin) has a D-type durometer (Shore hardness) of about 50-80 is used, and preferably has a hardness of 60-70 (according to JIS-K-6253 (1997) “Method of Hardness Testing of Vulcanized Rubber and Thermoplastic Rubber”). The thus formed resin plate 26, while not being heated, presses the material sheet 3A against the receiving cylinder 28 by a given force. Since the resin plate 26 is used, it is unlikely to cause scratches or cracks on the printing layer and a varnish layer respectively made of rigid coats cured by UV radiation, as compared with a case where a metal plate is used, and it is also unlikely to cause cracks on the surface of a polystyrene resin foam sheet having poor impact strength.

The receiving cylinder 28 may be formed by using a metal roll having a surface provided with resin or rigid rubber, or a metal roll with a thin sheet of paper wound in multiple layers.

The surface of the receiving cylinder 28 may have shallow depressions substantially matched to the linear depressions of the resin plate 26. In this case, linear depressions are formed on the side of the material sheet 3A facing to the receiving cylinder 28. When the side of the label with linear protrusions formed thereon acts as an outer side of the label, the inner side of the label has linear depressions while the outer side of the label hashlinear protrusions corresponding in position to the linear depressions. In this case, a material sheet having no heat sensitive adhesive layer is used. Even when the inner side of the label has liner depressions and the outer side of the label has linear protrusions, the height of the linear protrusions is smaller than the depth of the linear depressions, since the foam layer 10 is compressed by pressure.

The resin plate 26, the receiving cylinder 28 and the material sheet 3A each are set at such a temperature as to make the heat sensitive adhesive hard to become activated, namely 60° C. or lower, and preferably 50° C. or lower.

Then, the material sheet 3A having been subjected to the embossing is rolled up. A rolled material sheet 3B is slit to a given width, and cut into a given shape while being fed out of the slit roll by a label attaching machine (not illustrated), thereby producing labels 3. During transfer by a transfer means such as a suction drum, the labels 3, which have been cut into a given shape, have the heat sensitive adhesive heated and activated by blasts of hot air or infra-red radiation, and then each fitted around the main part 6 of the can body 1 filled with drink.

The thus drink filled metal cans are warmed by a hot vending machine or hot warmer and sold as hot drink. The heat sensitive adhesive of the label 3 has an adhesive force that is not likely to be reduced when it is heated to 60 to 65° C. by a hot vending machine or the like, so that the label 3 is not removed from the main part 6 but held thereon in a secured condition.

The can body 1, which is also heated to a high temperature in the same manner as the drink therein, allows a person to hold the can body 1 through the label 3 by the hand and hence preventing the hand from being heated. In addition, the arrangement with the embossed portion to be held by the hand is unlikely to cause slippage and hence allows for secured holding of the can body 1 by the hand.

The label 3 having the foam layer 10 of foamed polystyrene has a rigidity higher than a label having a foam layer 10 of polyethylene or polypropyrene, and bonded to the main part 6 of the metal can 1 along the entire circumference by the heat sensitive adhesive. This arrangement is preferable because of the reinforcing effect applied to the main part 6 of a metal can of thin steel or aluminium.

The thus structured label 3 may be applicable to various fields in addition to the above. For example, it is possible to provide no non-foam layer 11b on the inner side, in which the adhesive layer 14 may be laminated on the foam layer 10. It is also possible to laminate a polystyrene resin film having a thickness of about 20 μm to about 50 μm, which has been printed in a separate step, to the outer side prior to the embossing step. The foam layer 10 may be made of foamed polyolefin such as polyethylene resin or polypropylene resin. For example, the foam layer 10 made of foamed polyethylene is used as a label substrate having a rear side provided with the adhesive layer 14 and a front side provided with a polyethylene layer as the non-foam layer 11a, in which the polyethylene layer is provided thereon with the print 12 and the overcoat layer 13 is further provided on the polyethylene layer and the print 12. It is to be noted that the foam layer using foamed polystyrene resin is preferable since it has an excellent rigidity and workability in embossing by the resin plate 26 or is easy to be embossed as compared with foamed polyethylene.

The body of the container may be a glass bottle or a synthetic resin container other than a metal can. In case of a glass bottle, there is provided an effect of preventing bottle breakage. When an embossed portion is applied to a capped container, it preferably allows for secured holding of a container's main part when a cap is removed. A label of the present invention is also preferably used as a label for a cup-shaped container of synthetic resin adapted to contain food to be served after being heated by a microwave oven. The body of the container may contain those adapted to be cooled, in addition to such as a drink adapted to be heated. Particularly, a slippage prevention effect is remarkable for a freezer container of such as ice water, while the content is not limited to a specific one.

The pressing plate 26, which is made of resin as described above, allows for ease of manufacturing labels with no scratches or the like thereon at low cost. However, as long as a plate can apply a pressure while not being heated, it may be made of metal such as brass. For such a pressing plate made of metal, it is preferable to form an edge of each depression into R-shape so as not to cause scratch or the like on the surface of an material label.

In the method of manufacturing labels in the above embodiment, the surface of the material sheet 3A is subjected to corona discharge treatment and printing in the same step. In this respect, it is possible to previously subject the material sheet 3A to the corona discharge treatment so that the corona discharge treatment is performed in a step separate from the printing and its subsequent steps.

Although the label 3 in the above embodiment is a heat sensitive adhesive applied label which has a heat sensitive adhesive applied to the foam sheet, a heat shrinkable foam sheet may be used for the label 3. The heat shrinkable foam sheet may have a non-foam layer provided only on one side (a printing side), or may have non-foam layers provided respectively on both sides. For the heat shrinkable foam sheet, the material, thickness or expansion ratio of each of the foam layer and the non-foam layers are all may be the same as those as described above, and the shrinkage ratio of the heat shrinkable foam sheet is in the range of 30% to 70% at 120° C. (immersed in a glycerin bath for 10 seconds). Also, in a case where a heat shrinkable material is used for foam sheet, it is possible to emboss it in the same manner. Where the label 3 is thus made of a heat shrinkable foam sheet, it is possible to achieve attachment of the label on the container body 1 by feeding the sheet from the roll and cutting the same into individual labels 3; forming the adhesive layer 14 on the first edge 3a of the inner side of each label 3 by applying adhesive such as hot melt thereon; applying solvent being capable of dissolving polystyrene resin (ketone or ester) to the second edge 3b, placing the label 3 around the container body 1 with the first edge 3a bonded thereto and the second edge 3b overlapped to the first edge 3a and bonded thereto, thus forming the label 3 into a cylindrical shape; and heating the label 3 by a heater such as blasts of hot air, thereby making the label 3 shrink and hence allowing the same to be fully attached to the main part 6 of the container body 1. Alternatively, the attachment of each label is achieved by feeding the sheet from the roll and cutting the same into individual labels 3; placing each label 3 around a cylindrical mandrel or the like and having the opposite edges 3a, 3b overlapped to each other and bonded together along the bonded portion by heat sealing, thereby forming the label 3 into a cylindrical shape; fitting the cylindrical label 3 on the container body 1; and heating the label 3 by a heating means such as a heater so as to allow the same to shrink, so that the attachment of the label 3 to the container body 1 can be achieved without the necessity to bond the label 3 to the container body 1.

As described above, a label of the present invention allows for holding of a container body by the hand while preventing heating or cooling of the hand when it is attached to the container body. In addition, the linear depressions formed in the outer side of the label provide an uneven surface portion that makes the label hard to slip and hence the container body to slip off from the hand, as well as creates a decorative effect, produces a high quality feeling and provides a design having a perspective and three dimensional effect.

According to a method of manufacturing labels of the present invention, the outer side of each label is pressed by a resin plate having linear protrusions and therefore it is possible to prevent scratches or cracks on the outer side of the label, so that labels can be manufactured by a simple arrangement.

The label manufacturing method of the present invention does not require a pressing plate to be heated, and therefore is advantageous in the fact that labels with heat sensitive adhesive applied as adhesive for bonding of the labels can be easily manufactured.

1-8. (canceled)

9. A label for being attached to a main part of the body of a container, said label comprising a foam sheet having a foam layer, in which an outer side of the label has linear depressions formed by pressing the foam sheet so as to have partially thinned portions and provide an uneven surface portion.

10. The label according to claim 9, further comprising a heat sensitive adhesive layer on an inner side of the label.

11. The label according to claim 9, wherein the foam layer is made of foamed polystyrene resin and the linear depressions each have a width of 0.5-3.0 mm.

12. A method of manufacturing labels, said method comprising the steps of:
providing a label made of a foam sheet having a foam layer, and
pressing an outer side of each label with a resin plate having linear protrusions, thereby producing an embossed portion made up of linear depressions on the outer side of the label.

13. The method of manufacturing labels according to claim 12, further comprising providing an embossed portion on the outer side of the label and providing an adhesive layer on an inner side of the label.

14. A method of manufacturing labels comprising the steps of: providing a label made of foam sheet having a foam layer and a heat sensitive adhesive layer on an inner side thereof and pressing an outer side of each label with a pressing plate having linear protrusions, while applying no heat to the pressing plate, thereby producing an embossed portion made up of linear depressions on the outer side of the label.

15. A label for being attached to a main part of the body of a container, said label comprising a foam sheet having a foam layer, wherein an outer side of the label has linear protrusions that are formed by pressing the foam sheet in the thickness direction thereof so as to provide an uneven surface portion.

16. A method of manufacturing labels comprising the steps of:
providing a label made of a foam sheeting having a foam layer, and
pressing an inner side of each label with a pressing plate having linear protrusions, thereby producing an embossed portion made up of linear protrusions on an outer side of the label.
